(19) United States
(12) Patent Application Publication
(10) Pub. No.: US 2010/0038349 A1
(43) Pub. Date: Feb. 18, 2010

(54) LASER MARKING METHOD AND LASER MARKING SYSTEM

(75) Inventors: Chau-Yuan Ke, Pingtung County (TW); Chun-Chieh Huang, Taipei City (TW); Yuan-Chin Lee, Hsinchu City (TW); Kuen-Chiuan Cheng, Kaohsiung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/397,514

(22) Filed: Mar. 4, 2009

(30) Foreign Application Priority Data
Aug. 18, 2008 (TW) 97131475

(51) Int. Cl. B23K 26/00

(52) U.S. Cl. 219/121.69; 219/121.68

(57) ABSTRACT

A laser marking method and a laser marking system are provided. The laser marking method includes the following steps. Firstly, a substrate having at least M pattern lines is provided, wherein M is an integer which is larger than or equal to 1. Next, a laser beam is provided. Then, the laser beam is divided into at least two laser sub-beams including a first laser sub-beam and a second laser sub-beam. Afterwards, the second laser sub-beam is aimed at an (N-M)-th pattern line, and an N-th pattern line is marked by the first laser sub-beam, wherein N is an integer which is larger than or equal to M.

This application claims the benefit of Taiwan application Serial No. 97131475, filed Aug. 18, 2008, the subject matter of which is incorporated herein by reference.

### BACKGROUND OF THE INVENTION

1. Field of the Invention

The invention relates in general to a laser marking method and a laser marking system, and more particularly to a high-precision laser marking method and a laser marking system.

2. Description of the Related Art

Since American physicist Theodore Malman pioneered to use light and resonant cavity to generate a laser beam, laser has now been widely used in many fields. For example, laser is used to aim and position an object, precisely measure the distance, and mark, cut and electroplate the surface of an object. The application of laser in information products includes optical fiber communication, display, laser audio/video disc. Laser semiconductor has the features of light weight, compact size, high efficiency, low power consumption, long life-span, billion Hz modulated frequency, and easy control of output power via the adjustment of current. Thus, the application of laser plays an important role in electro-optical industry.

When laser is used in marking, laser beam points must be positioned with high precision. Referring to FIG. 1A, a conventional laser marking method using absolute rectangular coordinate (X-Y) as reference coordinate is shown. Conventional laser marking method adopts absolute rectangular coordinate in marking. As laser beam moves in both axes during marking process, each pattern line S must refer to the same original point O1.

Referring to FIG. 1B, a conventional laser marking method using absolute polar coordinate (R-θ) as reference coordinate is shown. Like absolute rectangular coordinate, conventional marking method uses absolute polar coordinate as a reference coordinate, so each pattern line S also must refer to the same original point O2.

When there is no feedback control between the laser beam and the substrate, marking precision is totally determined according to the precision of the precision platform. When the error in the positioning precision between light spots must be controlled to be less than tens of nanometer, the carrier is moved by high-precision moving motor.

### SUMMARY OF THE INVENTION

The invention is directed to a laser marking method and a laser marking system. The pattern line that has been marked is used as a reference for relative coordinate, and the design incorporating objective lens actuator and light sensing module is used.

According to a first aspect of the present invention, a laser marking method is provided. The laser marking method includes the following steps. (a) A substrate having at least M pattern lines is provided, wherein M is an integer which is larger than or equal to 1, and the M pattern lines can be marked by the laser marking system or any other marking facilities. (b) A laser beam is provided. (c) The laser beam is divided into at least two laser sub-beams including a first laser sub-beam and a second laser sub-beam. (d) The second laser sub-beam is aimed at an (N-M)-th pattern line, and an N-th pattern line is marked by the first laser sub-beam, wherein N is an integer which is larger than or equal to M.

According to a second aspect of the present invention, a laser marking system is provided. The laser marking system includes a carrier, a laser beam generating module and an optical module. The carrier is used for carrying a substrate having at least M pattern lines, wherein M is an integer which is larger than or equal to 1. The laser beam generating module is used for providing a laser beam. The optical lens module is used for dividing the laser beam into at least two laser sub-beams including a first laser sub-beam and a second laser sub-beam, aiming the second laser sub-beam at the (N-M)-th pattern line, and marking an N-th pattern line by the first laser sub-beam, wherein N is an integer which is larger than or equal to M.

The invention will become apparent from the following detailed description of the preferred but non-limiting embodiments. The following description is made with reference to the accompanying drawings.

### BRIEF DESCRIPTION OF THE DRAWINGS

FIG. 1A (Prior Art) shows a conventional laser marking method using absolute rectangular coordinate (X-Y) as reference coordinate;

FIG. 1B (PriorArt) shows a conventional laser marking method using absolute polar coordinate (R-θ) as reference coordinate;

FIG. 2 shows a laser marking system according to a preferred embodiment of the invention;

FIG. 3 shows an energy distribution chart of a laser beam passing through a grating;

FIG. 4 shows a flowchart of a laser marking method according to a preferred embodiment of the invention;

FIGS. 5A˜5B show a laser marking method where M=1 and relative rectangular coordinate is used as reference coordinate;

FIGS. 6A˜6B show a laser marking method where M=3 and relative rectangular coordinate is used as reference coordinate;

FIGS. 7A˜7B show a laser marking method where M=1 and relative polar coordinate is used as reference coordinate;

FIG. 8 shows the structure of various pattern lines;

FIGS. 9A˜9C show an adjustment of a predetermined distance; and

FIGS. 10˜10B show an objective lens actuator of FIG. 2.

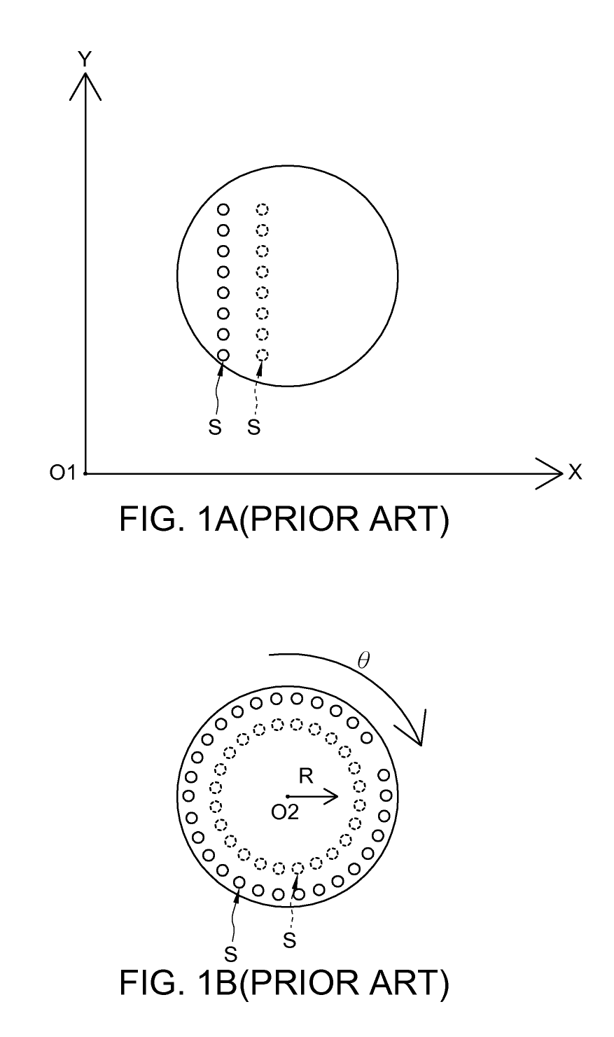

### DETAILED DESCRIPTION OF THE INVENTION

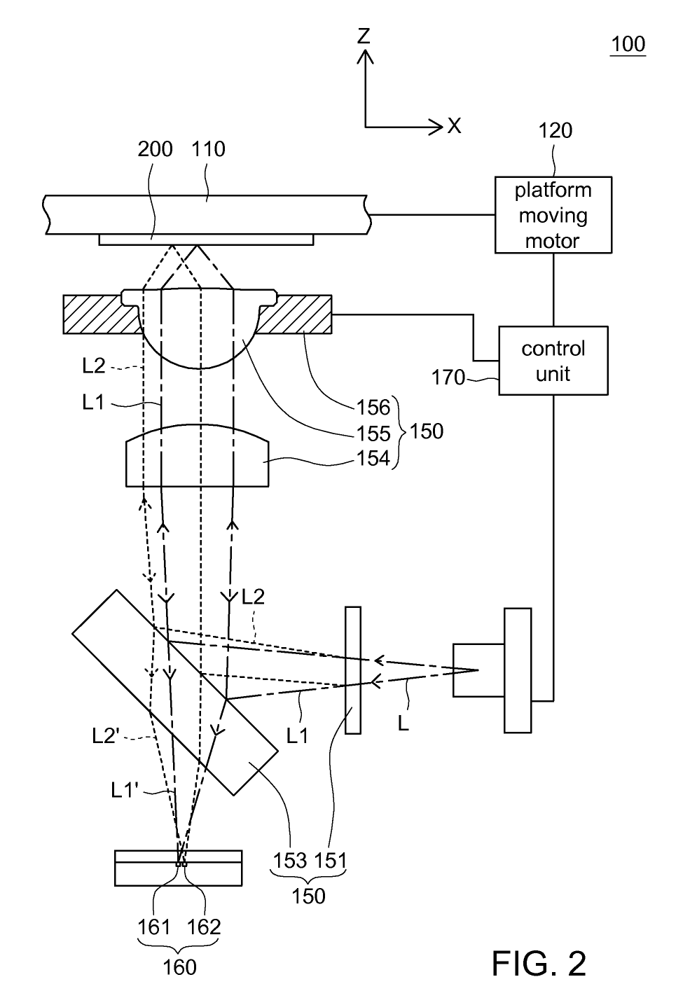

Referring to FIG. 2, a laser marking system 100 according to a preferred embodiment of the invention is shown. The laser marking system 100 includes a carrier 110, a platform moving motor 120, a laser beam generating module 130, an optical module 150, a light sensing module 160 and a control unit 170. The carrier 110 is used for carrying a substrate 200. The platform moving motor 120 is used for moving the carrier 110. The laser beam generating module 130 is used for providing a laser beam L. The optical lens module 150 includes a grating 151, a beam splifter 153, a collimator lens 154, an objective lens 155 and an objective lens actuator 156. The control unit 170 is used for controlling the platform moving motor 120 and the objective lens actuator 156.

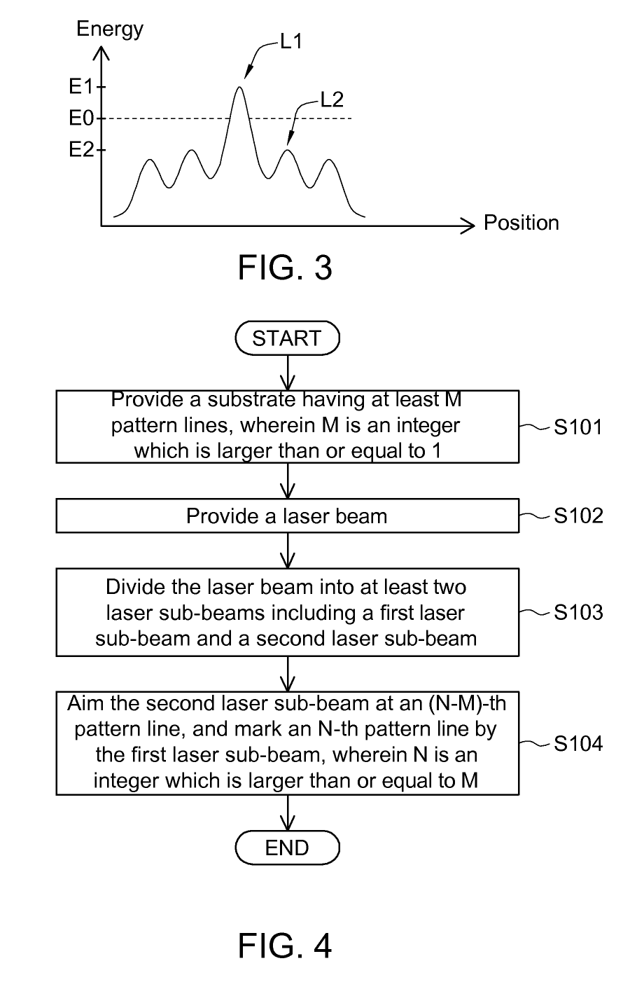

In terms of the path of the laser beam L, the laser beam L, after being emitted from the laser beam generating module 130, passes through the grating 151, and then the laser beam L is split into at least a first laser sub-beam L1 and a second laser sub-beam L2. For example, referring to FIG. 3, an energy distribution chart of a laser beam passing through a grating 151 is shown. After the laser beam L passes through the grating 151, the laser beam L is mainly divided into five wavebands with higher energy and distributed at five different positions. Let the waveband with highest energy be selected as the first laser sub-beam L1, and the other four wavebands be selected as the second laser sub-beam L2. In the present embodiment of the invention, the waveband with second highest energy is selected as the second laser sub-beam. The energy E1 of the first laser sub-beam is larger than the marking energy E0, and the energy E2 of the second laser sub-beam is smaller than the marking energy E0. For the convenience of elaboration, only the paths of the first laser sub-beam L1 and the second laser sub-beam L2 are shown FIG. 2, and other wavebands are omitted.

When the first laser sub-beam L1 and the second laser sub-beam L2 are emitted to the beam splitter 153, the first laser sub-beam L1 and the second laser sub-beam L2 are respectively split into a first split beam L1′ and a second split beam L2′.

When the first laser sub-beam L1 and the second laser sub-beam L2 pass through the collimator lens 154, the collimator lens 154 converts the diverged light into parallel lights.

Next, after the first laser sub-beam L1 and the second laser sub-beam L2 pass through the objective lens 155, the first laser sub-beam L1 and the second laser sub-beam L2 are focused on the substrate 200. Then, the first laser sub-beam L1 and the second laser sub-beam L2 are reflected from the substrate 200 and radiated to the light sensing module 160 through the objective lens 155, the collimator lens 154 and the beam splitter 153, the first split beam L1′ and the second split beam L2′.

As for how the above elements complete the laser marking process of the substrate 200 are elaborated below with accompanying drawings.

Referring to both FIG. 2 and FIG. 4. FIG. 4 shows a flowchart of a laser marking method according to a preferred embodiment of the invention. Firstly, the method begin at step S101, a substrate 200 having at least M pattern lines is provided, wherein M is an integer which is larger than or equal to 1. The pattern line can be marked by the laser marking system 100 or any other marking facilities.

Next, the method proceeds to step S102, a laser beam L is provided by the laser beam generating module 130.

Then, the method proceeds to step S103, the laser beam L is divided into at least two laser sub-beams by the grating 151 of the optical lens module 150. In the present embodiment of the invention, the laser beam L is divided into a first laser sub-beam L1 and a second laser sub-beam L2.

Next, the method proceeds to step S104, the second laser sub-beam L2 is aimed at the (N-M)-th pattern line, and the N-th pattern line is marked by the first laser sub-beam L1, wherein N is an integer which is larger than or equal to M.

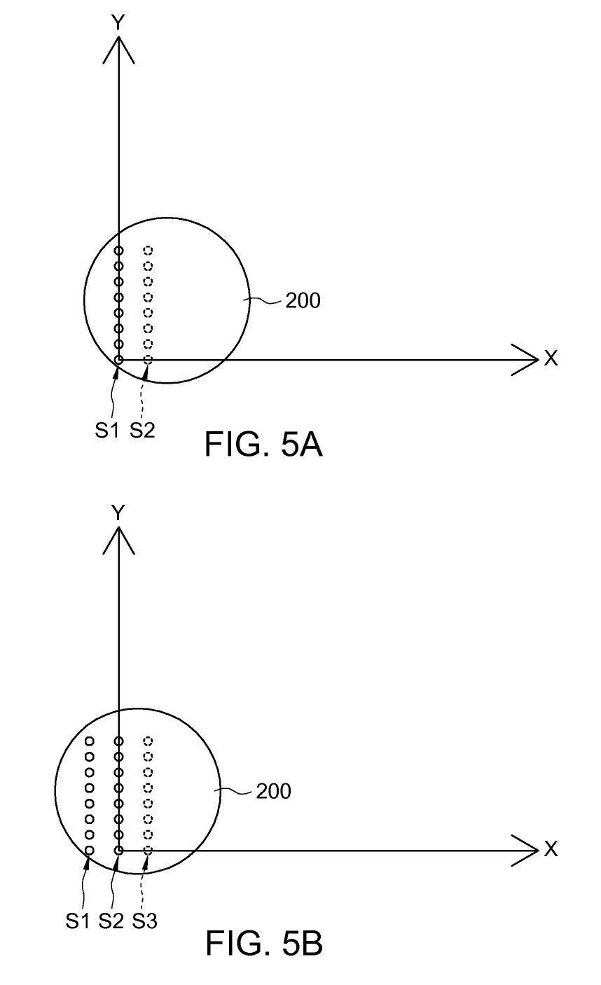

Let M=1. Referring to FIG. 5A˜5B, a laser marking method where M=1 and relative rectangular coordinate is used as reference coordinate is shown. As indicated in FIG. 5A, the substrate 200 has a first pattern line S1. The pattern line S1 can be marked by the laser marking system 100 or any other marking facilities. Next, the first pattern line S1 which has been marked can be used as a reference, and the second pattern line S2 is marked to the right of the first pattern line S1. The second pattern line S2 will be parallel to the first pattern line S1.

As indicated in FIG. 5B, the substrate 200 has a first pattern line S1 and a second pattern line S2, wherein the pattern line S1 and pattern line S2 can be marked by the laser marking system 100 or any other marking facilities. Next, the second pattern line S2 that has been marked can be used as a reference, and the third pattern line S3 is marked to the right of the first pattern line S2. By the same token, the (N-1)-th pattern line can be used as a reference and the N-th pattern line is marked to the right of the (N-1)-the pattern line by the laser marking system 100 or any other marking facilities. The N-th pattern line will be parallel to the (N-1)-th pattern lines.

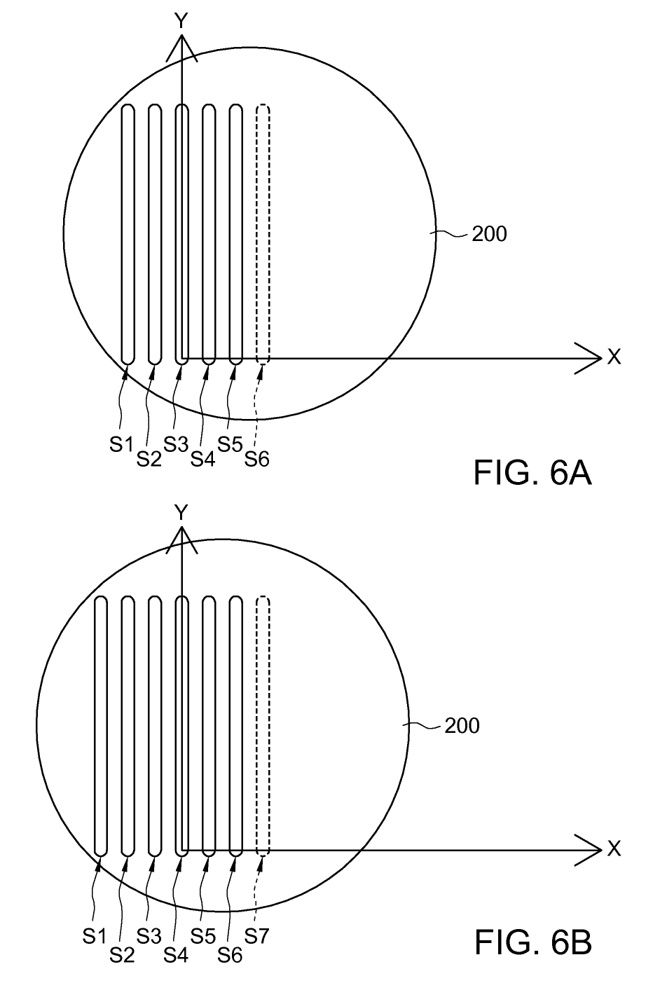

Let M=3. Referring to FIG. 6A˜6B, a laser marking method where M=3 and relative rectangular coordinate is used as reference coordinate is shown. As indicated in FIG. 6A, the substrate 200 has the first to the fifth pattern line S155. Next, the third pattern line S3 that has been marked can be used as a reference, and the sixth pattern line S6 is marked to the right of the third pattern line S3. The sixth pattern line S6 will be parallel to the third pattern line S3.

As indicated in FIG. 6B, the substrate 200 has the first to the sixth pattern line S1˜S6. Next, the fourth pattern line S4 that has been marked can be used as a reference, and the seventh pattern line S7 is marked to the right of the fourth pattern line S4. By the same token, the (N-M)-th pattern line can be used as a reference and the N-th pattern line is marked to the right of the (N-M)-the pattern line. The N-th pattern line will be parallel to the (N-M)-th pattern line.

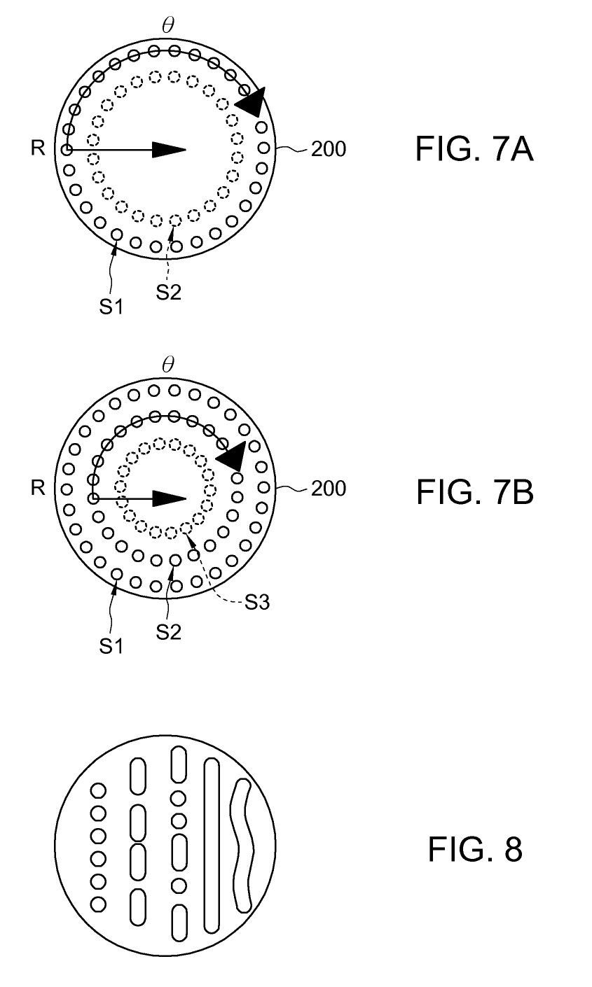

Referring to FIG. 7A˜7B, a laser marking method where M=1 and relative polar coordinate is used as reference coordinate is shown. As indicated in FIG. 7A, the substrate 200 has the first pattern line S1. Next, the first pattern line S1 that has been marked can be used as a reference, and the second pattern line S2 is marked inside the first pattern line S1. The second pattern line S2 will be parallel to the first pattern line S1.

As indicated in FIG. 7B, the substrate 200 has the first pattern line S1 and the second pattern line S2. Next, the second pattern line S2 that has been marked can be used as a reference, and the third pattern line S3 is marked inside the second pattern line S2. By the same token, the (N-1)-th pattern line can be used as a reference, and the N-th pattern line is marked to the right of the (N-1)-the pattern line. The N-th pattern line will be parallel to the (N- l)th pattern lines. That is, the laser marking method where the above relative coordinate is used can be applied to both rectangular coordinate and polar coordinate.

Referring to FIG. 8, the structure of various pattern lines is shown. However, the pattern line is not limited to the above types. For example, the pattern line can be a dot structure, a line structure or a mixed structure of dots and lines. The line structure is not limited to a straight line structure; a curve structure or a mixed structure of straight lines and curves would do as well.

Referring to FIG. 2. In step S103, the laser beam L is divided into the first laser sub-beam L1 and the second laser sub-beam L2 by the grating 151. The distance between the first laser sub-beam L1 and the second laser sub-beam L2 is adjusted by way of rotating or moving the grating 151.

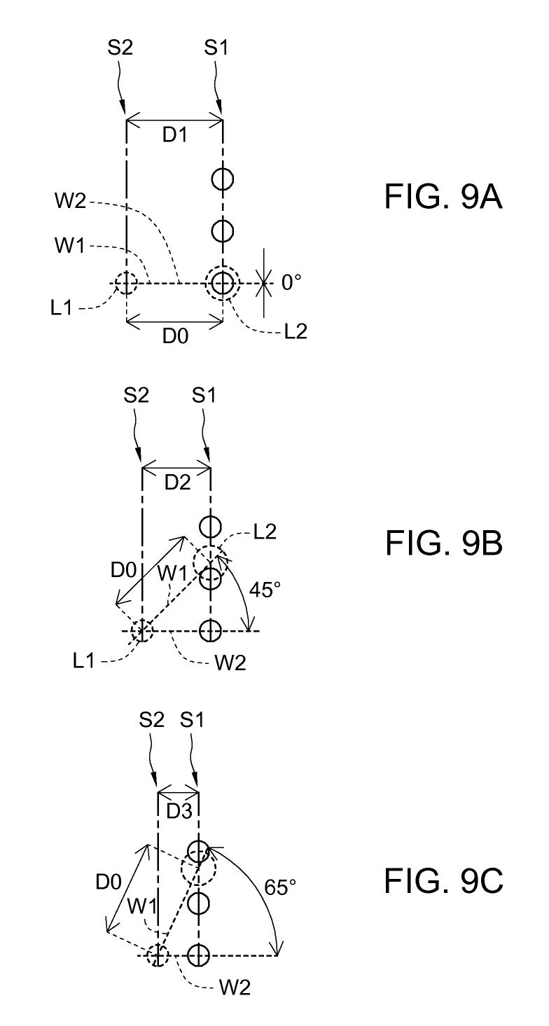

Referring to FIG. 9A˜9C, an adjustment of a predetermined distance is shown. As indicated in FIG. 9A, three marked points are illustrated at the right-hand side of the first pattern line S1, and the second laser sub-beam L2 is aimed at the first pattern line S1. The to-be-marked second pattern line S2 is positioned to the left of the first pattern line S1. Let the segment W1 be defined as the connecting line between the first laser sub-beam L1 and the second laser sub-beam L2, and the segment W2 is perpendicular to the first pattern line S1 and the second pattern line S2 (in FIG. 9A, the segment W1 is overlapped with the segment W2). When the contained angle between the segment W1 and the segment W2 is 0 degree, the distance D1 between the first pattern line S1 that has been marked and the to-be-marked second pattern line S2 is exactly equal to the distance DO between the first laser sub-beam L1 and the second laser sub-beam L2.

As indicated in FIG. 9B, when the contained angle between the segment W1 and the segment W2 is 45 degrees, the distance D2 between the first pattern line S1 that has been marked and the to-be-marked second pattern line S2 is exactly 1/\sqrt{2} times of the distance DO between the first laser sub-beam L1 and the second laser sub-beam L2.

As indicated in FIG. 9C, when the contained angle between the segment W1 and the segment W2 is 65 degrees, the distance D3 between the first pattern line S1 that has been marked and the to-be-marked second pattern line S2 is exactly cos 65° times of the distance D0 between the first laser sub-beam L1 and the second laser sub-beam L2.

That is, when the contained angle between the segment W1 and the segment W2 is 0, the distance between the first pattern line S1 and the to-be-marked second pattern line S2 is exactly equal to cosθ times of the distance DO between the first laser sub-beam L1 and the second laser sub-beam L2.

Referring to FIG. 2. In step S104, whether the first laser sub-beam L1 is focused on the substrate 200 is sensed by the light sensing module 160, and whether the second laser sub-beam L2 is aimed at the (N-M)-th pattern line is sensed by the light sensing module 160.

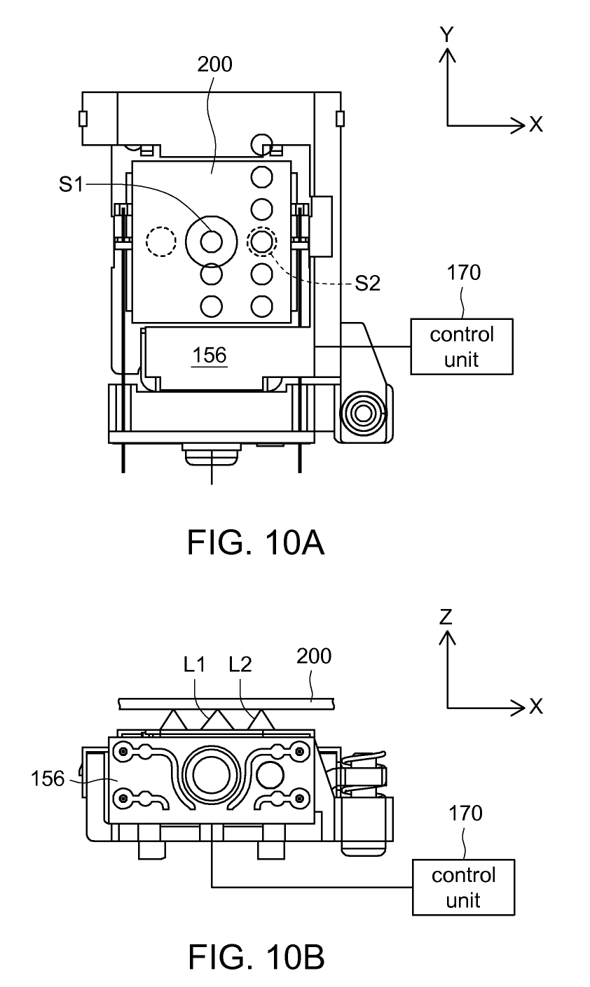

Referring to both FIG. 2 and FIGS. 10A˜10B for greater details. FIGS. 10A˜10B show an objective lens actuator 156 of FIG. 2. The light sensing module 160 has a first light sensing block 161 and a second light sensing block 162. The first light sensing block 161 is used for sensing whether the first laser sub-beam S1 is focused on the substrate 200. When the first light sensing block 161 sensed that the first laser sub-beam L1 is not focused on the substrate 200, the control unit 170 controls the objective lens actuator 156 to move the objective lens 155 along the Z-axial direction, such that the first laser sub-beam S1 is precisely focused on the substrate 200.

The second light sensing block 162 is used for sensing whether the second laser sub-beam is aimed at the (N-M)-th pattern line. When the second light sensing block 162 senses that the second laser sub-beam L2 is not aimed at the (N-M)-th pattern line, the control unit 170 controls the objective lens actuator 156 to move the objective lens 155 along the X-axial direction, such that the second laser sub-beam L2 is precisely aimed at the (N-M)-th pattern line.

During the marking process, the platform moving motor 170 moves the carrier 110 in the Y-axial direction, such that the second laser sub-beam L2 is moved along the (N-M)-th pattern line in the Y-axial direction and the N-th pattern line is marked by the first laser sub-beam L1 in the Y-axial direction.

The marking precision is controlled by the objective lens actuator 156 in the X-axial direction. In the present embodiment of the invention, the laser marking method and the laser marking system 100 achieve high precision marking by the objective lens actuator 156, and the platform moving motor 110 only moves in the Y-axial direction.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A laser marking method, comprising:
(a) providing a substrate having at least M pattern lines, wherein M is an integer which is larger than or equal to i;
(b) providing a laser beam;
(c) dividing the laser beam into at least two laser sub-beams including a first laser sub-beam and a second laser sub-beam; and
(d) aiming the second laser sub-beam at an (N-M)-th pattern line, and marking an N-th pattern line by the first laser sub-beam, wherein N is an integer which is larger than or equal to M.

2. The laser marking method according to claim 1, wherein in the step (d), the (N-M)-th pattern line is a dot structure, a line structure or a mixed structure of dots and lines.

3. The laser marking method according to claim 2, wherein in the step (d), the (N-M)-th pattern line is a straight line structure, a curve structure or a mixed structure of straight line and curve.

4. The laser marking method according to claim 1, wherein the step (c) comprises:
(c1) dividing the laser beam into the first laser sub-beam and the second laser sub-beam by a grating; and
(c2) adjusting the distance between the first laser sub-beam and the second laser sub-beam by rotating or moving the grating;
and the step (d) comprises.
(d1) providing an objective lens for focusing the first laser sub-beam and the second laser sub-beam on the substrate;
(d2) moving the objective lens, such that the second laser sub-beam is aimed at the (N-M)-th pattern line;
(d3) providing a light sensing module;
(d4) sensing whether the first laser sub-beam is focused on the substrate by the light sensing module; and
(d5) sensing whether the second laser sub-beam is aimed at the (N-M)-th pattern line by the light sensing module.

5. The laser marking method according to claim 4, wherein the light sensing module has a first light sensing block and a second light sensing block, in the step (d4), whether the first laser sub-beam is focused on the substrate is sensed by the first light sensing block, and the step (d5) whether the second laser sub-beam is aimed at the (N-M)-th pattern line is sensed by the second light sensing block.

6. A laser marking system, comprising:
a carrier used for carrying a substrate, the substrate has at least M pattern lines, M is an integer which is larger than or equal to 1;
a laser beam generating module used for providing a laser beam; and
an optical lens module used for dividing the laser beam into at least two laser sub-beams comprising a first laser sub-beam and a second laser sub-beam, aiming the second laser sub-beam at an (N-M)-th pattern line, and marking an N-th pattern line by the first laser sub-beam, wherein N is an integer which is larger than or equal to M.

7. The laser marking system according to claim 6, wherein the (N-M)-th pattern line is a dot structure, a line structure or a mixed structure of dots and lines.

8. The laser marking system according to claim 7, wherein the (N-M)-th pattern line is a straight line structure, a curve structure or a mixed structure of straight line and curve.

9. The laser marking system according to claim 6, wherein the optical lens module comprises:
a grating used for dividing the laser beam into the first laser sub-beam and the second laser sub-beam and adjusting the distance between the first laser sub-beam and the second laser sub-beam by way of rotating and moving;
an objective lens used for focusing the first laser sub-beam and the second laser sub-beam on the substrate; and
an objective lens actuator used for moving the objective lens, such that the second laser sub-beam is aimed at the (N-M)-th pattern line;
and the laser marking system further comprises:
a light sensing module used for sensing whether the first laser sub-beam is focused on the substrate and for sensing whether the second laser sub-beam is aimed at the (N-M)-th pattern line.

10. The laser marking system according to claim 9, wherein the light sensing module has a first light sensing block and a second light sensing block, the first light sensing block is used for sensing whether the first laser sub-beam is focused on the substrate, and the second light sensing block is used for sensing whether the second laser sub-beam is aimed at the (N-M)-th pattern line.
